(19) United States
(12) Patent Application Publication
(10) Pub. No.: US 2004/0101108 A1
(43) Pub. Date: May 27, 2004

(54) System and method of conducting digital x-ray analysis

(75) Inventor: Craig A. Charleton, Lancaster, CA (US)

Correspondence Address: GUY GOSNELL, ALSTON & BIRD, BANK OF AMERICA PLAZA, 101 S. TRYON STREET, SUITE 4000, CHARLOTTE, NC, 28280-4000, US

(73) Assignee: BOEING MANAGEMENT COMPANY

(21) Appl. No.: 10/306,297

(22) Filed: Nov. 27, 2002

(51) Int. Cl. H05G 1/02

(52) U.S. Cl. 378/198

(57) ABSTRACT

Method and apparatus for in-field digital x-ray analysis of a target body. An x-ray emitter, an x-ray receiver and a portable computer system provide a portable system for in-field digital x-ray inspection and analysis. An x-ray emitter is maneuvered to a location proximate a first side of a target body. An x-ray receiver is also maneuvered to a location proximate a second side of the target body independently of the emitter. X-ray emissions received from the x-ray emitter at the x-ray receiver are sent as data to a portable processor unit coupled to the receiver. A digital image is created based on the data. The digital image is then stored at the portable processor unit.

### BACKGROUND OF INVENTION

1. Field of the Invention

The invention relates to x-ray methods and systems. More specifically, the invention relates to methods and systems for in-field digital x-ray inspection and analysis.

### DESCRIPTION OF THE RELATED ART

Aircraft and spacecraft such as the Space Shuttle are periodically examined to assure mechanical and structural integrity. Numerous inspections are performed on mechanical and electrical systems. For instance, the structure and airframe of the Space Shuttle is thoroughly inspected prior to each launch using visual inspection and other techniques. One method of inspection of spacecraft in particular, is x-ray analysis of the airframe structure. Generally, the x-ray inspection of spacecraft has involved suspending an x-ray tube head and exposing x-ray sensitive film to an x-rays to create an image of the airframe. Various methods have been employed to hang the rather large films, such as suspension via a crane. Additionally, the level of radiant x-ray energy necessary to obtain quality film exposures requires that the entire region or building around the target body be evacuated of personnel for safety during the exposure period. The x-ray radiation exposure times vary greatly depending on the target body dimension, but usually require 5 to 10 minutes for a full exposure at a power of 100 kV at 12-15 mA. Therefore, the radiation produced in the x-ray process usually requires that inspections occur in radiation-proof buildings, or similarly confined areas since the OSHA requirements for safe x-ray exposure levels require a distance of 40 ft at 90 degrees off-target with present systems operated open-cone. Additionally, the films used for x-ray systems often employ hazardous materials and waste products in the emulsion or in the developing process. Furthermore, the exposed films must be developed to determine whether or not a successful x-ray is obtained. The latency of such exposures is quite high and consequently, over a thousand exposures must usually be taken for a given inspection each taking an average of 21 minutes to set. The large and heavy x-ray systems required for the inspection process often generate significant heat due to high-voltage operation. Many x-ray systems require a 220 volt or an industrial three-phase power connection, and a form of fluid cooling to allow continuous operation.

As such, prior x-ray inspection techniques are highly impractical for in-field use with aircraft or other targets due to safety concerns, and are very expensive for reusable launch vehicles such as the Space Shuttle. It would therefore be desirable to provide a system and method for in-field x-ray inspection and analysis that addresses these and other limitations.

### SUMMARY OF THE INVENTION

The present invention is directed to a system and method for conducting digital x-ray analysis of a target body. One aspect of the invention provides a method for conducting digital x-ray in a field environment. The method first provides for maneuvering an x-ray emitter to a location proximate to a first side of a target body to be inspected. Next, an x-ray receiver is maneuvered to a location proximate to a second side of the target body. The x-ray receiver is maneuvered independently of the x-ray emitter. The x-ray receiver receives x-ray emissions from the x-ray emitter and sends digital image data from the x-ray receiver to a portable processor unit coupled to the x-ray receiver. The portable processor unit creates, and stores, a digital image based on the digital image data.

Another aspect of the invention provides a portable system for conducting digital x-ray analysis for structural inspection in a field environment. An x-ray emitter unit and an x-ray receiver unit are coupled to a portable processor. In operation, the x-ray emitter is independently maneuvered to a first side of a target body and the x-ray receiver is independently maneuvered to a second side of the target body. The receiver may then receive emissions from the x-ray emitter and send a digital image data to the portable processing unit in the field.

The foregoing and other features and advantages of our invention are apparent from the following detailed description of exemplary embodiments, read in conjunction with the accompanying drawings. The detailed description and drawings are merely illustrative of the invention rather than limiting, the scope of the invention being defined by the appended claims and equivalents thereof.

### DESCRIPTION OF THE DRAWINGS

FIG. 1 is a block diagram of a system for portable digital x-ray imaging and analysis in accordance with the invention;

FIG. 2 is a second block diagram of the system of FIG. 1 depicting an external data store.

FIG. 3 is a block diagram illustrating an exemplary computer system that may be used to implement the invention.

FIG. 4 is a flow diagram illustrating a method for performing in-field digital x-ray imaging and analysis of aircraft in accordance with the invention;

FIG. 5 is a flow diagram illustrating a method for performing an in-field calibration of a digital x-ray imaging system as in FIGS. 1 and 2 in accordance with the invention; and

FIG. 6 is a diagram of a system for conducting in-field digital x-ray analysis as in FIGS. 1 and 2.

### DETAILED DESCRIPTION OF THE INVENTION

Throughout the specification and claims the term “coupled” means either a direct wired connection or connection through one or more passive or active components. For example, components such as a bidirectional data bus or a wireless connection may be used. The terms “processor unit, “processing unit,” “computer system,” and “server system” should be construed to be substantially equivalent.

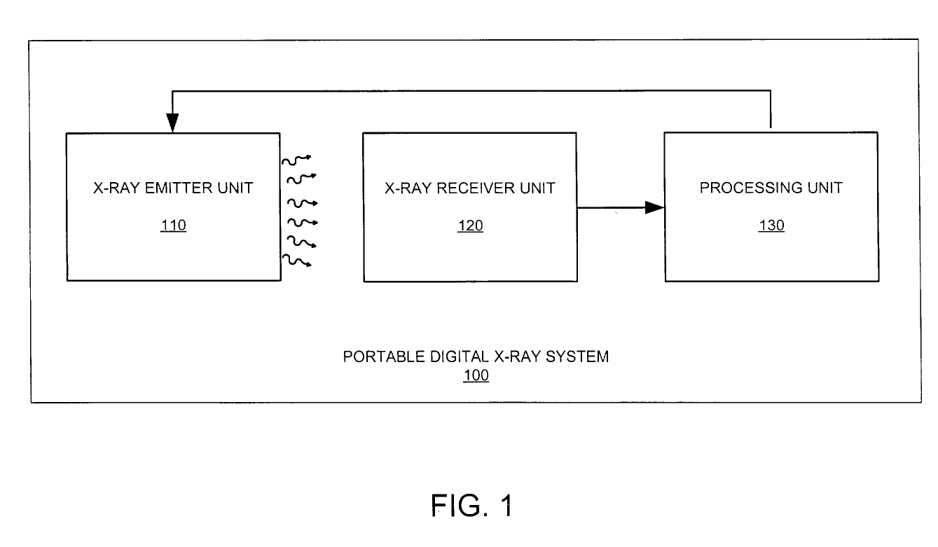

FIG. 1 is a block diagram of a system for portable digital x-ray imaging and analysis in accordance with the invention. FIG. 1 shows a portable digital x-ray system 100 (hereinafter, system) containing an x-ray emitter unit 110, an x-ray receiver unit 120, and a processing unit 130. The x-ray emitter unit 110 is shown emitting x-ray radiation to the x-ray receiver unit 120. The x-ray receiver unit 120 is shown coupled to the processing unit 130. The processing unit 130 is shown coupled to the x-ray emitter unit 110. Optionally, the processing unit 130 may be coupled to the x-ray emitter unit 110 for control functions.

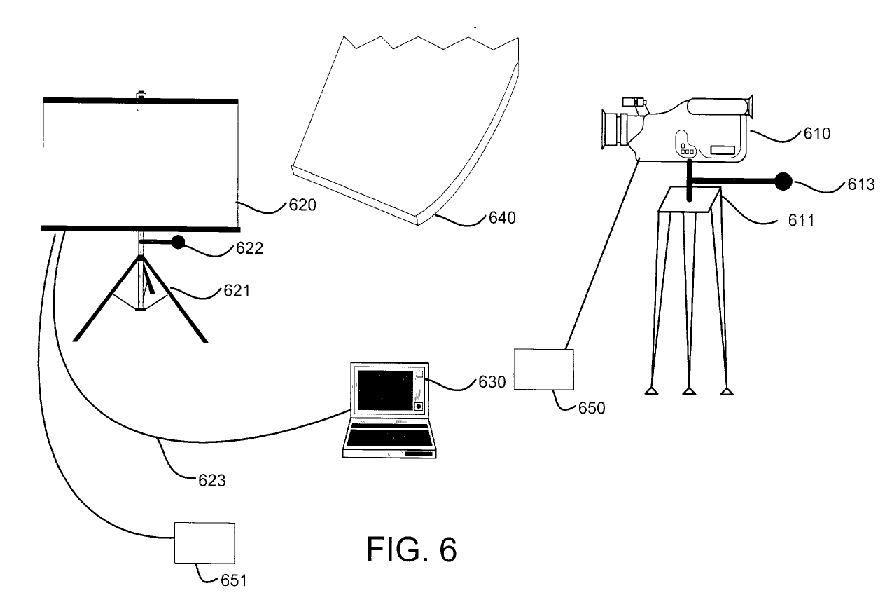

The x-ray emitter unit 110 (hereinafter, emitter unit) is a stand-alone assembly that may be positioned remotely from the x-ray receiver unit 120 and the processing unit 130. In the embodiment of FIG. 6, the emitter unit 110 is an assembly generally comprised of, but not limited to, an x-ray emitter tube 610 an emitter holder 611 and an emitter clamp 613. In the embodiment shown, the x-ray emitter tube 610 is electrically coupled to a power source 650, which selectively provides power to the emitter unit 610.

Examples of an emitter holder include: a tripod, a frame, a telescoping boom stand or the equivalent. In each case, the x-ray emitter tube may be attached to the emitter holder by a well known means, such as a clamp. As illustrated in the embodiment of FIG. 6, the x-ray emitter tube 610 is attached to the emitter clamp 613, so that it may be pivoted relative to the emitter holder 611. The x-ray emitter tube has a range of freedom when attached to the emitter holder 611 such that the x-ray emissions may be directed by maneuvering the x-ray emitter tube head and/or emitter holder. The embodiment of FIG. 6 illustrates a low-power type x-ray emitter tube such as, for example, the Hamamatsu Microfocus, which is available from the Hamamatsu Corporation. Low power x-ray emitter tubes are commercially available and may be operated at household line voltages (e.g. 100V) and without fluid cooling under normal operation, because they generate much less heat than high-power units to produce output powers of 130 kV at 300 to 500 μA. Additionally, the lower emitted power allows OSHA radiation exposure limits to be satisfied at a 15 ft distance for 90 degrees off-target operating open-cone. In the embodiment of FIG. 6, the x-ray tube 610 is shown coupled to a power source 650. Optionally, an electrical connection (not shown) may be implemented as a wired or wireless connection that communicates a voltage or current signal between a portable processor 630 and the power source 650 for commands, such as, for example, to start and stop emission or to engage a calibration cycle.

The x-ray receiver unit 120 (hereinafter, receiver unit) is a fully discrete assembly that may be positioned remotely from the emitter unit 120 and the processing unit 130. In the embodiment of FIG. 6 the receiver unit 120 is an assembly generally comprised of, but not limited to, an x-ray receiver panel 620 a receiver holder 621 and a receiver clamp 622. In the embodiment shown, the receiver panel 620 is electrically coupled to a power source 651, which selectively provides power to the receiver panel 620.

X-ray receiver panels are known to those in the art, and are commercially available from, for example, Varian Medical Systems and include amorphorous silicon and gadolinium oxysulphide types. Other possible semiconductive x-ray receiver materials will be known to those in the art and may be applied to the present invention. The x-ray receiver panel 620 produces an output image data signal based upon x-ray radiation impinging upon a detector array (not shown). In the embodiment of FIG. 6, the output of the x-ray receiver panel 620 is sent to a portable processor 630 though an electrical connection 623 as a time-varying voltage or current signal. The electrical connection 623 may be implemented as a wired or wireless connection that communicates the image data to the portable processor 630.

Examples of a receiver holder include: a tripod, a frame, a telescoping boom stand or the equivalent. In each case, the x-ray receiver panel may be attached to the receiver holder by a well known means, such as a clamp. As illustrated in the embodiment of FIG. 6, the x-ray receiver panel 620 is attached to the receiver clamp 622 so that it may be pivoted relative to the receiver holder 621. The x-ray receiver panel has a range of freedom when attached to the receiver holder 621 such that the x-ray emissions emitted by the emitter tube 610 may be received by maneuvering the x-ray receiver panel 620. The embodiment of FIG. 6 illustrates an amorphorous silicon x-ray receiver such as, for example, the Paxscan 4030 from Varian Medical Systems. Semiconductive x-ray panels are generally more sensitive to x-ray radiation than a comparable x-ray film emulsion for a given area and therefore allow the use of lower power x-ray emitter tubes and narrower x-ray beams. Additional safety benefits are obtained because the chemicals and byproducts associated with x-ray film emulsions and processing are avoided by the use of the receiver panel.

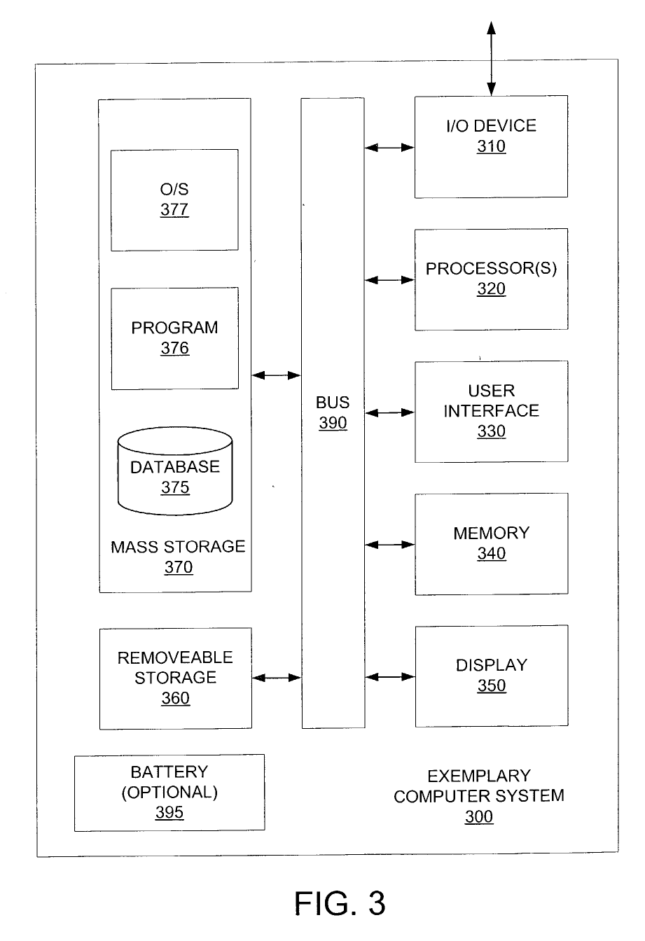

The processing unit 130 is a mobile computer system of very high processing capacity. In one implementation, processing unit 130 may be a multi-processor or double-stack portable workstation. The processing unit 130 provides real-time processing of digital x-ray image data based upon the output of the receiver unit 120. The processing unit 130 is configured for portable use, and may optionally include a battery. The exemplary embodiment of FIG. 3 illustrates a typical configuration for the processing unit 130. Processing of image data received from a receiver unit 120 is performed in real-time by the processing unit 130 to provide x-ray images directly from the received image data. The processing unit may be configured to decipher multiple layers of metallic and non-metallic bodies such as may occur in an air or spacecraft. In one embodiment, the processing unit 130 is configured to provide resolution enhancement of digital images. In another embodiment, the processing unit may be configured to perform an automated fracture analysis of the digital image. Resolution enhancement and computer-aided image analysis techniques are well known to practitioners of imaging science and therefore will not be further discussed. In yet another embodiment, the processing unit may be configured to archive digital images to a high-capacity removable storage medium. In still another embodiment, the processing unit 130 may be configured to provide automated system calibration implemented by controlling x-ray emission from the emission unit 110 and monitoring the response data from the receiving unit 120. In the embodiment of FIG. 6, the processing unit 630 is a portable digital imaging workstation having a dual-stack processor capable of in-field real-time digital image processing.

In one embodiment, the sensitivity of the x-ray receiver panel allows the use of lower-power narrow-beam x-ray radiation. The in-field x-ray imaging and analysis is essentially compartmentalized by reducing scatter x-ray radiation and the overall radiated x-ray power. Using well known safety practices, more than one system 100 may be simultaneously operated at different locations on the same target body, significantly reducing the operational time for a complete x-ray inspection.

In the embodiment of FIG. 6, a target body 640 is illustrated positioned between the emitter tube 620 and the receiver panel 620. The target body 640 of FIG. 6 is illustrated as an aircraft wing-tip. However, a target body may comprise any object for which an in-field x-ray analysis is desired and that is able to be utilized with the invention.

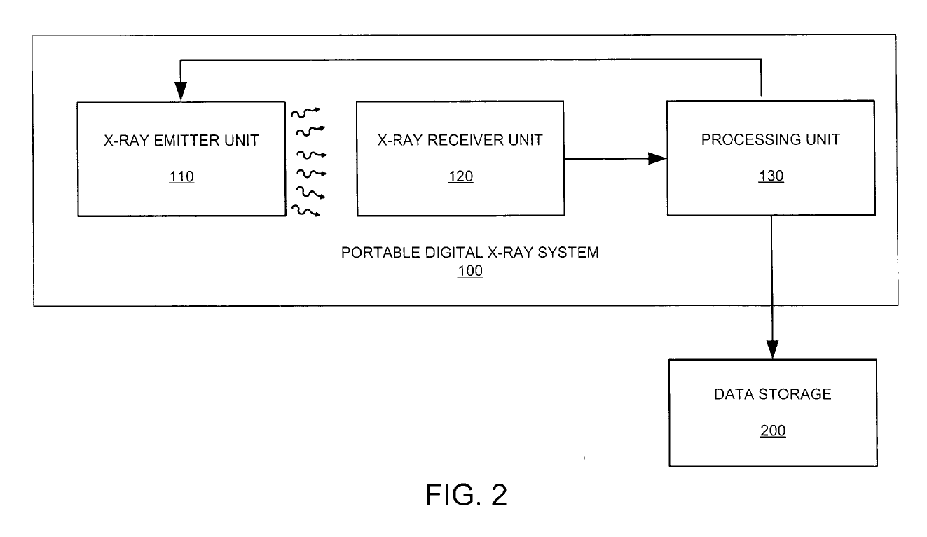

FIG. 2 is a second block diagram of the system of FIG. 1 including an external data storage device. FIG. 2 shows the portable digital x-ray system 100 of FIG. 1 containing an x-ray emitter unit 110, an x-ray receiver unit 120, and a processing unit 130. FIG. 2 also shows a high capacity data storage device 200 external to system 100. The x-ray emitter unit 110 is shown emitting x-ray radiation to the x-ray receiver unit 120. The x-ray receiver unit 120 is shown coupled to the processing unit 130. The processing unit 130 is shown coupled to the x-ray emitter unit. The data storage device 200 is shown coupled to the processing unit 130.

The data storage device 200 is a high capacity storage medium suitable for archiving tens of thousands of digital images. The data storage device may be a second computer system configured as a server computer, a high-capacity hard-drive, a recordable optical drive, a solid state memory, a magnetic tape or an equivalent. In one embodiment, the data storage device 200 is not coupled to the processing unit 130 in the field when the digital images are obtained, but at a later time to download an archive of digital images captured in the field. In another embodiment, the data storage device 200 is coupled to the processing unit 130 in the field to allow a download of digital images, and then disconnected from the processing unit once all images have been successfully archived. In yet another embodiment, the data storage device 200 is a component of a workstation server computer to allow additional digital processing of saved digital x-ray images.

FIG. 3 is a block diagram illustrating an exemplary computer system 300 that may be used to implement the invention described in FIGS. 1, 2 and 6. More specifically, FIG. 3 shows a computer system 300 comprising an I/O device 310; a processor 320; a user interface 330; memory 340; a display 350; removable storage 360; a bus 390; and, mass storage 370 containing a database 375, programs 376 and an operating system 377. An optional battery 395 may be included for a mobile implementation. In FIG. 3 the I/O device 310, the processor 320, the user interface 330, the memory 340, the display 350, the removable storage 360 and the mass storage 370 are all shown coupled to the bus 390. The I/O device 310 is additionally shown enabled for communication external to computer system 300. A power supply (not shown) is electrically coupled to the computer system 300 to provide power to components requiring power.

The I/O device 310 is a device capable of bidirectional data communication with a device external to the computer system 300. Examples of I/O devices include serial, parallel, USB, Ethernet and IEEE 802.11 compliant wireless devices, for example.

The processor 320 is a computing device usually containing memory and data control capability, such as caching and the like. The processor 320 may be integrated with supporting hardware such a video controller, a storage device controller and the like. The processor 320 generally executes instructions of a computer program such as program 376, for example. In one implementation, the processor 320 is a dual-stack processor capable of parallel code execution and accelerated image processing capacity. In another embodiment, two or more processors 320 are operated in parallel for increased processing capacity.

The user interface 330 is a device such as a keyboard, a mouse, a pointing device, a pen, a microphone or another device used to provide a data entry interface with a user of the computer system 300.

The memory 340 is a hardware or virtual storage device for computer code and data that the processor is manipulating. Memory 340 includes all dynamic memory external to the processor including video memory, additional cache memory and the like. Portions of mass storage 370 may also be used to provide virtual memory that may be used interchangeably with the memory 340.

The display 350 is a visual display such as a CRT, LCD, plasma or projection display used to provide a user with a visual interface with the computer system 300. In one embodiment, system 300 may have two or more display devices.

The removable media 360 is any device that provides a high-capacity removable medium for storing computer code or image data such as a magnetic disc drive, a writable optical disc drive or the equivalent.

The mass storage 370 is any device that provides storage for computer code and data such as a hard disk drive a recordable optical medium and the like. In one embodiment, the mass storage 370 is provided by a second computer server system over a network (not shown). The mass storage generally contains the operating system 377, programs 376 and may include a database 375. Programs include applications for execution by the computer system 300. In one embodiment, the operating system 377 is optimized for a portable digital workstation capable of very high capacity processing of digital image data.

The bus 390 is a bidirectional communication device that enables data communication between the various devices of computer system 300. The bus 390 may include a processor and other logic devices to enable multiple data clock speeds and protocols depending upon the connected devices.

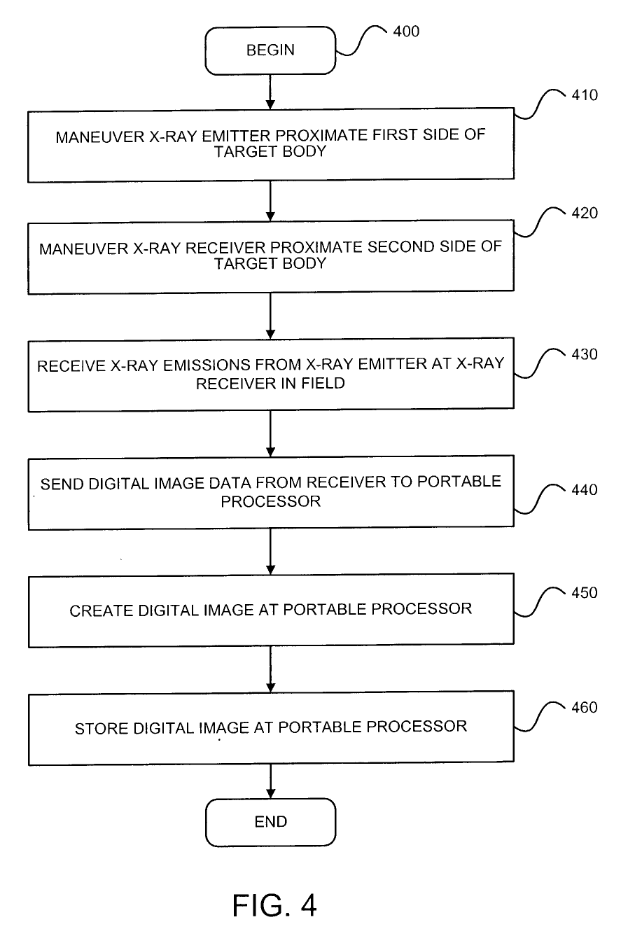

FIG. 4 is a flow diagram illustrating a method for performing in-field digital x-ray imaging and analysis in accordance with the invention. Process 400 begins in step 410. Process 400 may be enabled using a portable digital x-ray system such as system 100 of FIGS. 1 and 2.

In step 410, an x-ray emitter is maneuvered proximate a first side of a target body. The target body may be a portion of airframe structure of an aircraft or spacecraft, as depicted in FIG. 6, or another object suitable for x-ray analysis. The x-ray emitter is a device such as emitter unit 110 of FIGS. 1 and 2. The emitter may be maneuvered into position at any time prior to performing an x-ray inspection or a system calibration. In the embodiment of FIG. 6, the x-ray emitter tube 610 is maneuvered to direct x-ray emissions through a target body 640.

In step 420, an x-ray receiver is maneuvered proximate a second side of the target body. The x-ray receiver is a device such as x-ray receiver unit 120 of FIGS. 1 and 2. In the embodiment of FIG. 6, the receiver panel 620 is positioned to align the plane of the panel with an x-ray beam emitted by the x-ray emitter tube 620. The receiver may be maneuvered into position at any time prior to performing an x-ray inspection or a system calibration. Generally, the emitter unit and the receiver unit are maneuvered in step 410 and step 420 to opposing positions facing one another centered through the target body.

In step 430, emissions from the x-ray emitter maneuvered in step 410 are received at the x-ray receiver maneuvered in step 420. The x-ray emissions may be initiated by a portable processor, such as processing unit 130, or manually by an operator. In one embodiment, the x-ray emissions are initiated as part of a system calibration sequence. The emissions may be discrete or continuous and of any duration necessary for the desired process. Experience with certain airframes indicates a range the x-ray emissions should last from about 15 to about 45 seconds.

In step 440, digital image data based on the x-ray emissions received in step 430 is sent to a portable processor. The portable processor is a processing unit such as processing unit 130 of FIGS. 1 and 2. The digital image data sent in step 440 is in a form that the portable processor is able to receive. In one embodiment the digital image data is automatically received and cached when the data is sent in step 440. The digital image data may be sent at any time after the x-ray emissions are received in step 430.

In step 450, a digital image is created at the portable processor based on the digital image data sent in step 440. The digital image may be created at any time after the image data is sent in step 440. The created image is a digital x-ray image reflecting the portion of the airframe structure of the target body positioned between the emitter unit and the receiver unit. In one embodiment, step 450 includes digital processing of the digital data sent in step 440 to enhance the image quality. In another embodiment, step 450 includes an automated computer-aided fault analysis of the image data sent in step 440. In yet another embodiment, automated computer aided fault analysis includes iterative examination of the data and/or additional mathematical transformations that seek to expose or identity cracks, faults or other structural defects in the x-ray images of the target body. In one embodiment, steps 430, 440 and 450 all occur in approximately 45 seconds.

In step 460, the digital image created in step 450 is stored. The digital image may be stored at any time after the image is created in step 460. The image is generally stored to a high-capacity removable media such as a writable optical media or a removable hard drive. In one embodiment, the image is stored to a server computer connected to the portable processor. In another embodiment, the data is first stored to a storage device on the portable processing unit and then duplicated on an archival medium external to the system 100. Process 400 terminates after step 460 is completed.

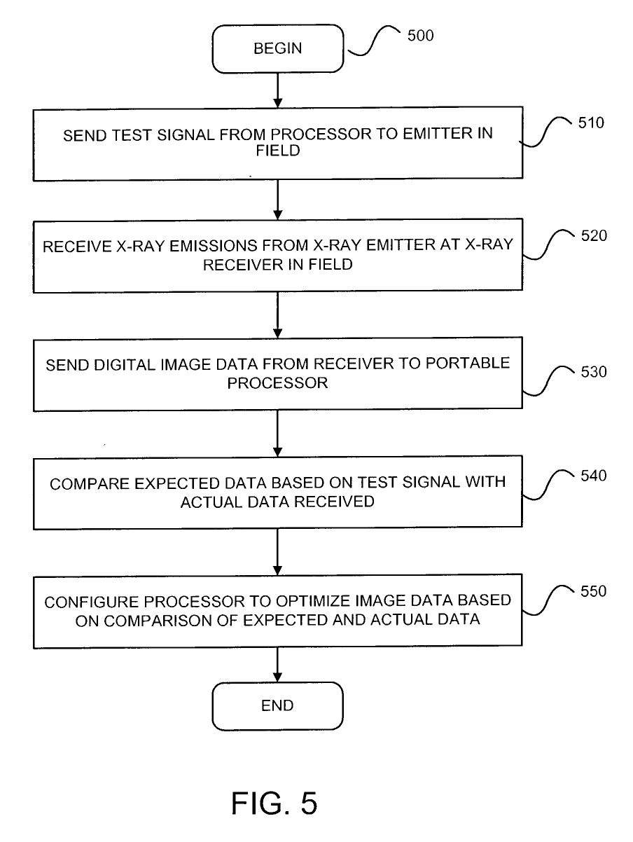

In a first example of process 400, the United States Space Shuttle is inspected for airframe faults in the field using a portable digital x-ray system according to the invention. A first and a second x-ray team set up two digital x-ray imaging systems, as in FIGS. 1 and 2, in a hangar or on the open tarmac. The first crew sets up a system at the rear of the Space Shuttle. Simultaneously, the second crew sets up an x-ray system at the front of the Shuttle, both crews operating according to the methods of FIGS. 4 and 5. Working systematically and following standard safety practices, the crews are able to safely operate the two x-ray systems at the same time to inspect the Shuttle saving hundreds of hours over prior inspection regimens.

In a second example, in-field inspection of commercial airliner fleets is conducted using a portable digital x-ray system according to the invention. An inspection crew following standard safety practices performs a periodic in-field digital x-ray inspection of a commercial aircraft using the system of FIGS. 1 and 2. The inspection crew sets up the digital x-ray system according to the methods of FIGS. 4 and 5. The inspection crew is then able to perform a complete documented x-ray analysis of an aircraft in the field. All digital x-ray images are preserved for the plane's history file. With the assistance of the system of the invention, commercial application of in-field digital x-ray inspection is practical as a standard practice for commercial airline fleet maintenance. While the foregoing examples illustrate application of the system to air and spacecraft, the invention may be utilized for x-ray inspection of any target body in a field environment. Other uses for the invention include inspection of cargo containers, use for in-field bomb inspection for bomb squads and anti-terrorist teams, and inspection of parcels, for example.

FIG. 5 is a flow diagram illustrating a method for performing an in-field calibration of a digital x-ray imaging system, as in FIGS. 1 and 2, in accordance with the invention. Process 500 begins in step 510. Process 500 may be enabled using a portable digital x-ray system such as system 100 of FIG. 1, and operated according to process 400 of FIG. 4.

In step 510, a test signal is sent from a processor, such as processing unit 130 of FIG. 1, to an x-ray emitter, such as emitter unit 110 of FIG. 1, in a field setting. In another embodiment (not shown) an operator manually initiates a test signal being sent to the x-ray emitter. The test signal may be sent at any time after the system 100 is set up in the field. The test signal may be a control signal or a power signal representative of a current, voltage or a digitally modulated representation of either. The test signal is in a form that the emitter is able to receive. The test signal may be sent through a wired or wireless connection in a digitally modulated or analog form. In one embodiment, the test signal initiates an x-ray emission from the x-ray emitter unit with predetermined spread, intensity, and duration characteristics.

In step 520, x-ray emissions from the x-ray emitter are received at an x-ray receiver in the field. The x-ray receiver is a device such as receiver 120 of FIGS. 1 and 2. The x-ray emissions may be received at any time after the test signal is sent in step 510.

In step 530, digital image data based on the x-ray emissions received in step 520 is sent to processing unit 130. The digital image data sent in step 530 is in a form that the portable processor is able to receive. In one embodiment, the digital image data is automatically received and cached when the data is sent in step 530. The digital image data may be sent at any time after the x-ray emissions are received in step 520.

In step 540, digital image data received in step 530 is compared with expected data based on the test signal sent in step 510. The data may be compared at any time after the image data is sent in step 530. The calibration system performing the data comparison is generally a computer program that operates on the portable processor unit 130.

In step 550, the portable processor is configured to optimize digital image data based on the data comparison in step 540. The configuration may occur at any time after the data comparison is made in step 540. The configuration generally comprises applying a correction coefficient vector to image data to account for variability in the environment, positioning of the emitter and receiver units and other variables. In one embodiment, process 500 terminates after step 550. In another embodiment, process 500 repeats until predetermined optimization criteria are realized. While the preferred embodiments of the invention have been shown and described, numerous variations and alternative embodiments will occur to those skilled in the art. Accordingly, it is intended that the invention be limited only in terms of the appended claims.

What is claimed is:

1. A method of conducting digital x-ray analysis for in-field inspection of a target body, the method comprising:
maneuvering an x-ray emitter to a location proximate a first side of a target body;
maneuvering an x-ray receiver to a location proximate a second side of the target body, wherein the x-ray receiver is maneuvered independent of the x-ray emitter;
receiving x-ray emissions from the x-ray emitter at the x-ray receiver in the field environment;
sending digital image data from the receiver to a portable processor unit coupled to the receiver;
creating a digital image based on the data at the portable processor unit; and, storing the digital image at the portable processor unit.

2. The method of claim 1 further comprising archiving the digital image to a data store external to the portable processor unit.

3. The method of claim 2 wherein the data store is selected from the group consisting of a server computer, a hard drive, a recordable compact disc, a recordable digital versatile disc, and a flash memory.

4. The method of claim 1 further comprising:
processing the digital image data.

5. The method of claim 4 wherein processing the digital image data includes processing the digital data for image enhancement prior to creating the digital image.

6. The method of claim 4 wherein the digital image data is processed to provide automated computer aided fault analysis.

7. The method of claim 4 wherein the processing resolves structural layers in the digital image.

8. The method of claim 4 wherein the processing includes calibrating the receiving of x-ray emissions by the receiver at the portable processing unit.

9. A portable system for conducting in field digital x-ray analysis of a target body, comprising:
an x-ray emitter unit;
an x-ray receiver unit;
a portable processing unit operably coupled to the x-ray receiver unit, wherein the x-ray emitter unit is independently maneuvered to a first side of a target body and the x-ray receiver unit is independently maneuvered to a second side of the target body, wherein the x-ray receiver unit receives emission from the x-ray emitter unit and sends digital image data to the portable processing unit in a field environment.

10. The system of claim 8 wherein the x-ray emitter unit includes an emitter holder selected from the group consisting of a tripod, a frame, and a boom stand.

11. The system of claim 8 wherein the x-ray receiver unit includes a receiver holder selected from the group consisting of a tripod, a frame, and a boom stand.

12. The system of claim 8 wherein the portable processing unit is a multi-processor mobile computer.

13. The system of claim 8 wherein the x-ray receiver is a semiconductive x-ray sensitive panel.

14. The system of claim 8 further comprising a second processing unit external to the portable processing unit and operably coupled to the portable processing unit.

15. The system of claim 14 wherein the second processing unit is a server computer.

16. The system of claim 8 further comprising an x-ray calibration system including a computer readable medium containing a computer program with instructions for:
sending a test signal from the processing unit to the x-ray emitter unit,
wherein the x-ray receiver unit is receiving x-ray emissions from the at the x-ray emitter unit and sending digital image data based on the received x-ray emissions to the portable processing unit from the x-ray receiver unit,
comparing an expected digital image data based on the test signal with the image data received from the x-ray receiver unit, and
configuring the processing unit to optimize received image data based on the comparison of the expected image data and the received image data.

17. The system of claim 8 wherein the portable processing unit has a computer readable medium containing a computer program with instructions for:
receiving image data from the x-ray receiver to the processing unit,
processing the image data in real time, and
generating a digital image based on the digital image data.

18. The system of claim 17 further comprising instructions for storing the digital image.

19. The system of claim 17 further comprising instructions to process the digital data to perform an automated fault analysis.

20. A portable system for conducting in field digital x-ray analysis of a target body, comprising:
x-ray emitter unit means for emitting an x-ray radiation through a target body;
x-ray receiver unit means for receiving the x-ray emissions which pass through the target body; and
portable processing means operably coupled to the x-ray receiver unit means for receiving image signals from the x-ray receiver unit means and creating an image.
